(19) United States
(12) Patent Application Publication
(10) Pub. No.: US 2025/0010107 A1
(43) Pub. Date: Jan. 9, 2025

(54) EMERGENCY APPARATUS

(71) Applicant: Brian Do, Anaheim, CA (US)

(72) Inventor: Brian Do, Anaheim, CA (US)

(21) Appl. No.: 18/764,760

(22) Filed: Jul. 5, 2024

Related U.S. Application Data
(60) Provisional application No. 63/512,228, filed on Jul. 6, 2023.

(51) Int. Cl. A62B 3/00; A01B 1/02; A45F 3/00; A62B 33/00; A63B 29/02; F21V 33/00; F21Y 115/10

(52) U.S. Cl. CPC A62B 3/00; A01B 1/022; A45F 3/00; A62B 33/00; A63B 29/021; F21V 33/0064; A45F 2003/006; F21Y 2115/10

(57) ABSTRACT

An emergency apparatus having: a foldable shovel having: a shovel handle; a shovel head pivotally engaged with the shovel handle; a lighting apparatus associated with the shovel handle; a leveler apparatus associated with the shovel handle; and a utility slot nested within the shovel handle; and a carrying case configured to engage with the foldable shovel and secure the foldable shovel to a user. Different embodiments of the carrying case may be capable of providing additional functions, such as providing redundant lighting and leveler apparatuses, and additional storage space. The emergency apparatus is sufficiently small and lightweight to avoid encumbering the user.

### CROSS-REFERENCE TO RELATED APPLICATIONS

This application claims the benefit of U.S. Provisional Application No. 63/512,228, filed Jul. 6, 2023, which is hereby incorporated by reference, to the extent that it is not conflicting with the present application.

### BACKGROUND OF INVENTION

### 1. Field of the Invention

The invention relates generally to emergency equipment and specifically to emergency apparatuses having a shovel configured to be worn by a user.

### 2. Description of the Related Art

During a natural disaster or other emergency situation in which a user is buried under snow, dirt, rubble, or other debris, a digging device, such as a shovel, may be particularly useful for the buried user to have access to, in order to allow them to free themselves and escape to safety. This being said, conventional shovels are often quite large and cumbersome, thus making them less realistic to carry around due to the increased bulk and weight and more difficult to operate if the buried user's range of motion is limited by surrounding debris. In order to escape to safety after being buried, the buried user will need to reorient themselves and determine which direction to dig in order to surface and escape, which in most cases is directly upward. Furthermore, without being able to see, as a result of lacking a light source, overcoming such a challenge may be exceedingly difficult, even if the buried user has a shovel, due to the buried user being unable to view and assess their surroundings. These complications, in conjunction with potentially limited oxygen, require a buried user to act quickly in order to dig themselves out and escape.

Therefore, there is a need to solve the problems described above by proving a device and method for an emergency apparatus that is sufficiently small to be easily carried/worn by a user, which provides the user with a digging device, a light source and a means to determine which direction is up.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, an emergency apparatus is provided, the emergency apparatus comprising: a foldable shovel having: a shovel handle having a top portion and a bottom portion; a securing cord attached to the bottom portion the shovel handle; a shovel pivot attached to the top portion of the shovel handle; a shovel head attached to the shovel pivot; a pair of protruding teeth attached to a bottom portion of the shovel head; a lighting apparatus associated with the shovel handle; a leveler apparatus associated with the shovel handle; and a utility slot nested within the shovel handle; and a carrying case configured to engage with the foldable shovel and secure the foldable shovel to a user; wherein the securing cord is configured to selectively surround and engage with a wrist of the user and each tooth of the pair of protruding teeth is configured to collide with the shovel handle upon rotation of the shovel head to be about parallel with the shovel handle. Thus, an advantage is that the foldable shovel may be selectively folded and unfolded as needed by the user, thus allowing the foldable shovel to be less cumbersome while in the folded orientation. Another advantage is that a user that is buried may utilize the lighting apparatus to view their surroundings and the leveler apparatus to determine which way is up, thus allowing them to know which direction they will need to dig to escape when buried in rubble, snow, etc. Another advantage is the utility slot may be used to hold important emergency supplies, such as bandages, painkillers, food, etc. that a user may need while buried. Another advantage is that the carrying case itself may comprise another lighting apparatus, another leveler apparatus and a utility pocket to provide helpful redundancies in the event of the any device on the foldable shovel becomes damaged or is otherwise inaccessible.

In another aspect, an emergency apparatus is provided, the emergency apparatus comprising: a foldable shovel having: a shovel handle; a shovel head pivotally engaged with the shovel handle; a lighting apparatus associated with the shovel handle; a leveler apparatus associated with the shovel handle; and a utility slot nested within the shovel handle; and a carrying case configured to engage with the foldable shovel and secure the foldable shovel to a user. Again, an advantage is that the foldable shovel may be selectively folded and unfolded as needed by the user, thus allowing the foldable shovel to be less cumbersome while in the folded orientation. Another advantage is that a user that is buried may utilize the lighting apparatus to view their surroundings and the leveler apparatus to determine which way is up, thus allowing them to know which direction they will need to dig to escape when buried in rubble, snow, etc. Another advantage is the utility slot may be used to hold important emergency supplies, such as bandages, painkillers, food, etc. that a user may need while buried. Another advantage is that the carrying case itself may comprise another lighting apparatus, another leveler apparatus and a utility pocket to provide helpful redundancies in the event of the any device on the foldable shovel becomes damaged or is otherwise inaccessible.

In another aspect, an emergency apparatus is provided, the emergency apparatus comprising: a foldable shovel having: a shovel handle; a shovel head pivotally engaged with the shovel handle; a protruding tooth associated with and extending away from the shovel head; a lighting apparatus associated with the shovel handle; a leveler apparatus associated with the shovel handle; and a utility slot nested within the shovel handle. Again, an advantage is that the foldable shovel may be selectively folded and unfolded as needed by the user, thus allowing the foldable shovel to be less cumbersome while in the folded orientation. Another advantage is that a user that is buried may utilize the lighting apparatus to view their surroundings and the leveler apparatus to determine which way is up, thus allowing them to know which direction they will need to dig to escape when buried in rubble, snow, etc. Another advantage is the utility slot may be used to hold important emergency supplies, such as bandages, painkillers, food, etc. that a user may need while buried.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1A illustrates the front elevation view of a foldable shovel in the unfolded orientation, according to an aspect.

FIG. 1B illustrates the front perspective view of a foldable shovel in the folded orientation, according to an aspect.

FIG. 1C illustrates the side perspective view of a user having an emergency apparatus secured to their arm, according to an aspect.

FIG. 2A illustrates the front perspective view of a shovel bag, according to an aspect.

FIG. 2B illustrates the rear perspective view of a shovel bag, according to an aspect.

FIG. 2C illustrates the side perspective view of a user wearing an emergency apparatus having a shovel bag, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

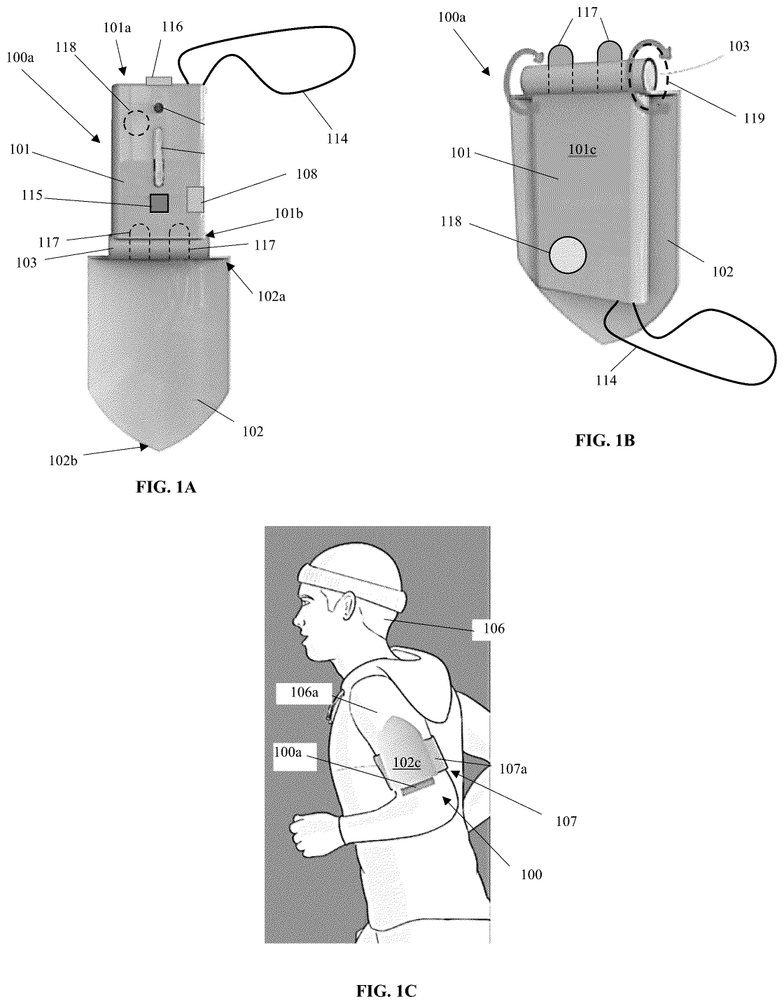

FIG. 1A illustrates the front elevation view of a foldable shovel 100a in the unfolded orientation, according to an aspect. FIG. 1B illustrates the front perspective view of a foldable shovel 100a in the folded orientation, according to an aspect. FIG. 1C illustrates the side perspective view of a user 106 having an emergency apparatus 100 secured to their arm 106a, according to an aspect. In an embodiment, the emergency apparatus 100 may comprise a foldable shovel 100a, the foldable shovel 100a having a shovel handle 101, and a shovel head 102 pivotally engaged with the shovel handle 101, and a carrying case, such as a shovel holster 107 of FIG. 1C, configured to selectively hold the foldable shovel 100a. The foldable shovel 100a may be configured such that the shovel head 102 may be selectively locked or set into the unfolded orientation of FIG. 1A, wherein the shovel head 102 extends away from and is about parallel with the shovel handle 101, to enable efficient digging with said foldable shovel 100a, as seen in FIG. 1A. As seen in FIG. 1B, a shovel angle 119 may be formed between the shovel head 102 and the shovel handle 101. In said embodiment, this shovel angle 119 may be formed between the back surface 101c of the shovel handle 101 (seen in FIG. 1B) and the back surface 102c of the shovel head 102 (seen in FIG. 1C). In an embodiment, the shovel angle 119 of the foldable shovel may be about 180 degrees (e.g., about parallel), with the shovel head 102 extending away from the shovel handle 101, as seen in FIG. 1A. In an embodiment, the shovel angle may be 180 degrees±2 degrees.

The shovel handle 101 may be pivotally engaged with the shovel head 102 through the utilization of a shovel pivot 103 disposed between and attached to or otherwise engaged with the shovel head 102 and the shovel handle 101. In an embodiment, the shovel pivot 103 may be engaged with a top portion 101b of the shovel handle 101 and a bottom portion 102a of the shovel head 102. This shovel pivot 103 may be any suitable hinge, joint, etc., configured to facilitate the rotation of the shovel head 102 between the folded orientation of FIG. 1B and the unfolded orientation of FIG. 1A. The top portion (“tip”) 102b of the shovel head 102 may be appropriately shaped to suitably dig through a designated material. For example, a shovel head 102 having a sharper tip 102b may be utilized for foldable shovels 100a configured to dig in dirt, when compared to the shovel head 102 of a foldable shovel 100a configured to dig in sand.

In an embodiment, the shovel pivot 103 may be configured to allow the foldable shovel 100a to be selectively “locked” or set into the unfolded orientation of FIG. 1A, in order to keep the shovel in its operational configuration during use. In said embodiment, a pair of protruding teeth 117 may be associated with and extended out from the shovel head 102, such that upon rotation of the shovel head 102 from the folded orientation of FIG. 1B to the unfolded orientation of FIG. 1A, the protruding teeth 117 collide with the shovel handle 101, thus preventing the shovel head 102 from rotating further beyond the unfolded orientation of FIG. 1A. As such, the protruding teeth 117 may help keep the foldable shovel 100a in the unfolded orientation of FIG. 1A while in use, by having the usage of the shovel to dig force the pair of protruding teeth 117 against the shovel handle 101, thus preventing the foldable shovel 100a from rotating/collapsing into the folded orientation of FIG. 1B, while further preventing the shovel head 102 from rotating beyond the angle allowed by the protruding teeth 117, wherein the shovel head 102 is about parallel with the shovel handle 101, as seen in FIG. 1A. It should be understood that alternative structures and mechanisms (or different quantities of protruding teeth 117) may also be utilized to lock or set the foldable shovel 100a to the unfolded orientation during use, as long as proper device function (e.g., selective folding of the foldable shovel 100a) is maintained. In an embodiment, each protruding tooth 117 may be attached to the bottom portion 102a of the shovel head 102.

In an embodiment, the emergency apparatus 100 may further comprise a lighting apparatus 104 and a leveler apparatus (“level indicator”) 105. In said embodiment, the lighting apparatus 104 and the leveler apparatus 105 may be engaged with, nested/embedded within or otherwise associated with an element of the foldable shovel 100a, such as the shovel handle 101. In an embodiment, the emergency apparatus 100 may be configured such that while in the foldable shovel 100a is in the folded orientation, as shown FIG. 1B, the lighting apparatus 104 and the leveler apparatus 105 are covered between the shovel handle 101 and the shovel head 102, such that the lighting apparatus 104 and the leveler apparatus 105 are protected from impacts, falling debris, etc., while in the folded orientation.

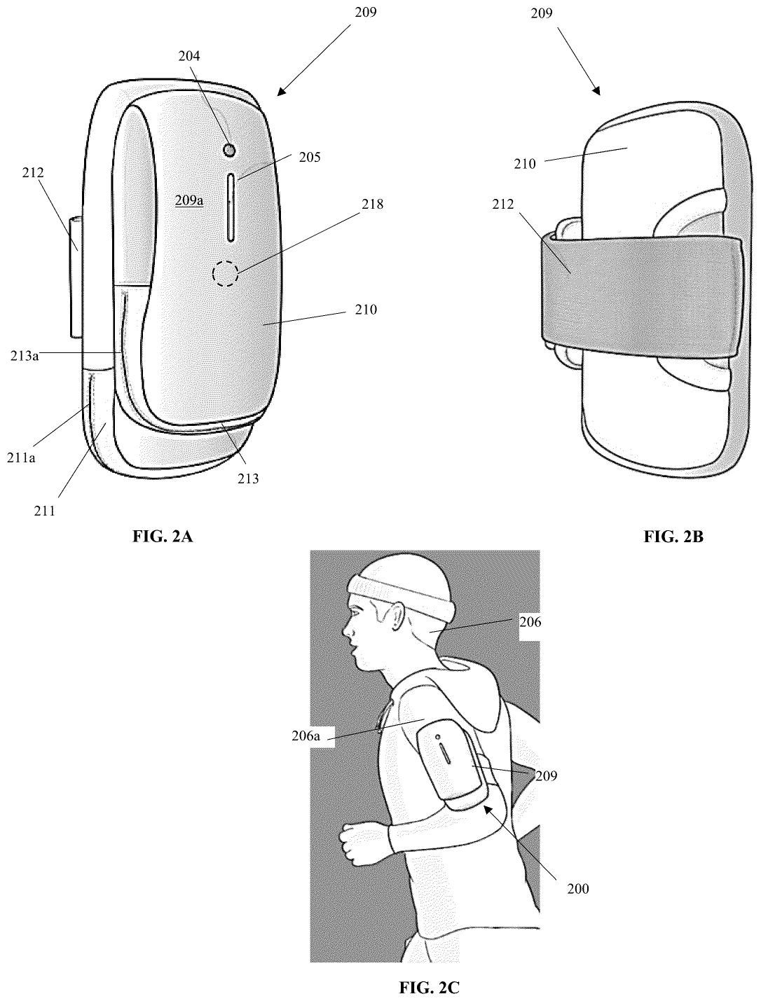

In an embodiment, a battery compartment 118 configured to hold a battery may be nested within the shovel handle 101, wherein in the battery compartment is in electrical communication with each element of the foldable shovel 100a that requires power to operate (e.g., the GPS device, the lighting apparatus 104, etc.). A similar battery compartment, such as battery compartment 218 of FIG. 2B may be nested within or otherwise associated with a corresponding carrying case to power elements on said carry case, as will be discussed in greater detail hereinbelow.

The lighting apparatus 104 may be any sufficiently bright light emitting device configured to allow the user to see their surroundings, including but not limited to: a light emitting diode (“LED”) light, an incandescent light, a halogen lamp, etc. In an embodiment, an LED light may be preferred for the lighting apparatus 104 for its durability, low power consumption and efficient light output. The leveler apparatus 105 may be any suitable device for allowing the user to determine which direction is up to reorient themselves, such as but not limited to: mercury levelers, or other fluid based levelers which use the force of gravity on a fluid to indicate which direction is up, electronic levelers, etc. In an embodiment, a mercury leveler may be preferred for the leveler apparatus 105 for its ease of use and analog (non-electronic) nature, thus not requiring any power to operate. It should be understood that the lighting apparatus 104 may also be utilized to illuminate the leveler apparatus 105, such that the leveler apparatus 105 may be made visible to the user 106 in dark environments.

It should be understood that the foldable shovel 100a may be sufficiently small and lightweight, such that a user 106 may easily carry the foldable shovel 100a within a corresponding compact carrying case, such as the shovel holster 107. In an embodiment, the shovel holster 107 may comprise an elastic securing member 107a configured to be selectively engaged with the user 106, wherein the securing member 107a surrounds a user's arm. In said embodiment, the shovel holster 107 may further comprise a suitable attachment mechanism (not shown) such as a clip, ring, or slot configured to engage with the foldable shovel. This attachment mechanism may secure the foldable shovel 100a to the user with sufficient force to prevent it from being dislodged unless the user is intentionally grabbing the foldable shovel 100a off of the shovel holster.

The shovel holster 107, and other carrying cases, may be configured to be comfortably worn by a user 106 without noticeably encumbering the user 106, as seen in FIG. 1C. The shovel holster 107 may be configured such that the foldable shovel 100a may be nested within or otherwise engaged with the shovel holster 107, while the shovel holster 107 itself is simultaneously engaged with the user 106. While the shovel holster 107 may be seen attached to the user's arm 106a in FIG. 1C, it should be understood that the shovel holster 107 may alternatively be attached to any other suitable portion of the user 106 that enables quick access to the foldable shovel 100a. In alternative embodiments, the shovel holster 107 may be attached to a user's leg/ankle, torso, or any other suitable portion of the user 106 that said user can easily access.

In addition to having a lighting apparatus 104 and a leveler apparatus 105, the emergency apparatus 100 may further comprise at least one utility slot 108. In an embodiment, the utility slot 108 may be nested within the shovel handle 101 to facilitate easy access to said utility slot 108 by the user 106 holding the foldable shovel 100a. The utility slot 108 may be sufficiently sized to contain items that a user may find useful in an emergency situation (e.g., being buried by debris, snow, etc.), including but not limited to: medicine, such as painkillers, first aid equipment, such as medical wipes and bandages, food, etc. This utility slot 108 may be configured to remain closed while not in use, but also may be easily opened by the user 106 with minimal effort. In order to prevent the user 106 from dropping and losing the foldable shovel 100a during use, said emergency apparatus 100 may further comprise a securing cord (“looper cord”) 114 engaged with the foldable shovel 100a. The securing cord 114 may be attached to, engaged with or otherwise associated with the bottom portion 101a of the shovel handle 101 (e.g., the side of the shovel handle opposite the shovel pivot 103), wherein the securing cord 114 is configured to selectively surround and engage with the wrist/hand of a user 106 during use. The engagement of the foldable shovel 100a with the user 106 through the utilization of the securing cord 114 may ensure that the foldable shovel 100a remains accessible to the user 106, even if the debris covering the user shifts or moves, causing the user 106 to drop the foldable shovel 100a.

As disclosed hereinabove, the emergency apparatus 100 may include a carrying case, such as the shovel holster 107 or the hereinbelow described shovel bag 209 of FIGS. 2A-2C, used to hold the foldable shovel 100a of the emergency apparatus 100 while said foldable shovel 100a not in use. As described hereinabove, the shovel handle 101, shovel head 102, and shovel pivot 103 may together be referred to as the foldable shovel 100a, wherein each carrying case is configured to secure the foldable shovel 100a to the user 106.

It should be noted that additional safety amenities may also be provided on the foldable shovel 100a of FIG. 1A-1C, the shovel holster 107 of FIG. 1C and/or the shovel bag 209 of FIG. 2A-2C in order to further aid a user 206 during an emergency situation. An emergency whistle 116 may be implemented into or otherwise associated with the shovel handle 101 of foldable shovel 100a of FIG. 1A-1C, the shovel holster 107 of FIG. 1C or the shovel bag 209 of FIGS. 2A-2C, in order to allow the user 106, 206 to attempt to alert nearby rescuers of their location. In another embodiment, a global positioning system (“GPS”) device 115 may be associated with, nested/embedded within or otherwise incorporated into the shovel handle 101 of the foldable shovel 100a of FIG. 1A-1C, the shovel holster 107 of FIG. 1C and/or the shovel bag 209 of FIG. 2A-2C, in order to allow rescuers to more easily locate the user wearing said device(s). In an embodiment, the GPS device 115 and the leveler apparatus 105 may be almost entirely surrounded by the structure of the shovel handle 101, such that only the portion(s) of the device configured to display relevant information to the user is visible to the user.

FIG. 2A illustrates the front perspective view of a shovel bag 209, according to an aspect. FIG. 2B illustrates the rear perspective view of a shovel bag 209, according to an aspect. FIG. 2C illustrates the side perspective view of a user 206 wearing an emergency apparatus 200 having a shovel bag 209, according to an aspect. It should be understood that various embodiments of the carrying case may be utilized to allow a user 206 to easily carry a foldable shovel of an emergency apparatus 200, such as foldable shovel 100a of FIG. 1. Unlike the shovel holster 107 of FIG. 1C, the disclosed shovel bag 209 of FIG. 2A-2C may be configured to have additional safety amenities/devices on the shovel bag 209 itself, as will be described in greater detail hereinbelow. It should be understood that the emergency apparatus 200 of FIG. 2C may comprise of a shovel bag 209 and a foldable shovel, such as foldable shovel 100a of FIG. 1A, nested within the shovel bag 209.

In an embodiment, the shovel bag 209 comprises a bag body 210, a main compartment 211 nested within or otherwise engaged with the bag body 210, wherein the main compartment 211 is configured to selectively hold the foldable shovel 100a of FIG. 1A-1B, and at least one securing strap 212 associated with the bag body 210, wherein the at least one securing strap 212 is configured to engage with the user 206 to secure the shovel bag 209 to the user 206. In an embodiment, the shovel bag 209 may further comprise a utility pocket 213 nested within or otherwise engaged with the bag body 210, wherein the utility pocket 213 is configured to hold items that would be useful to an individual in an emergency situation, such as food/water, medicine and first aid equipment. This utility pocket 213 may function similarly to the utility slot 108 of the emergency apparatus 100 of FIG. 1A, and may be provided alongside or may replace the utility slot 108 of the emergency apparatus 100, depending on the needs of the application. In an embodiment, the shovel bag 209 may comprise a main compartment zipper 211a configured to be used to selectively open the main compartment 211. In an embodiment, the shovel bag 209 may comprise a utility pocket zipper 213a configured to be used to selectively open the utility pocket 213.

Similarly to the foldable shovel 100a of FIG. 1, the shovel bag 209 may be provided with various safety amenities/devices. In an embodiment, the shovel bag 209 further comprises a corresponding lighting apparatus (“case lighting apparatus”) 204 and a corresponding leveler apparatus (“case leveler apparatus”) 205 engaged with, embedded within or otherwise associated with bag body 209. The lighting apparatus 204 and the leveler apparatus 205 of the shovel bag 209 of FIG. 2A-2B may be similar or the same as the lighting apparatus 104 and the leveler apparatus 105 of the emergency apparatus 100 of FIG. 1. It should be understood that, in some embodiments, the shovel bag 209 of FIG. 2A-2C and the foldable shovel 100a of FIG. 1A-1C may each have their own lighting apparatus 204, 104 and leveler apparatus 205, 105, thus providing redundant lighting and leveler devices in the event of the failure or damage of one of these apparatuses on either structure. In said embodiments, the lighting apparatus 204 on the shovel bag 209 may be referred to as an “auxiliary lighting apparatus” 204 and the leveler apparatus 205 on the shovel bag 209 may be referred to as a an “auxiliary leveler apparatus” 205.

In an alternative embodiment, the lighting apparatus 204 and the leveler apparatus 205 may only be provided on the shovel bag 209 or the foldable shovel of the emergency apparatus 200 to allow for simplification of the emergency apparatus 200. The shovel bag 209 may be configured such that the lighting apparatus 204 and the leveler apparatus 205 are both visible on the front surface 209a of said shovel bag 209, thus facilitating easy access to said lighting apparatus 204 and the leveler apparatus 205 by the user 206 without requiring them to open the shovel bag 209.

It should be understood that, much like the shovel holster 107 of FIG. 1C, the shovel bag 209 of FIG. 2A-2C may be attached to any applicable portion of the user 206 that said user 206 can easily reach. In an embodiment, the shovel bag 209 may be configured to be engaged with or otherwise associated with the arm 206a of the user 206. In alternative embodiments, the shovel bag 209 may be configured to engage with or be associated with the user's leg/ankle, elbow, torso, etc. Regardless of the positioning of the shovel bag 209 of FIG. 2A-2C, or shovel holster 107 of FIG. 1C, whichever carrying case is utilized to hold/engage with the foldable shovel 100a should be sufficiently accessible to the user 206, such that the user 206 may easily access the held foldable shovel, even while said user 206 is covered in rubble, snow, etc. from an avalanche, earthquake, landslide or any other kind of disaster or event.

In order to ensure the proper operation of the foldable shovel 100a of FIG. 1A-1C, the shovel holster 107 of FIG. 1C and the shovel bag 209 of FIG. 2A-2C, each structure may be made from lightweight, but sufficiently durable materials. In an embodiment, the foldable shovel 100a and its various structural elements (e.g., the shovel handle 101, shovel head 102, shovel pivot 103) may be made of a sturdy and durable, but lightweight material, such as hard plastic (e.g., Acrylonitrile butadiene styrene (ABS)) or metal, such as steel, in order to ensure the foldable shovel 100a remains intact and operational during use. As is understood, different embodiments of the foldable shovel 100 may be configured to dig through different materials, such as sand, snow, dirt, etc. The material(s) used to make the foldable shovel 100a may be varied in accordance with said foldable shovel's intended use case, to minimize weight while optimizing strength.

The carrying case, such as the shovel holster 107 of FIG. 1C or the shovel bag 209 of FIG. 2A-2C, may be made of a durable, but sufficiently flexible material, to allow the carrying case to hold the foldable shovel 100a while securely engaging with the user 106, 206. In an embodiment, the shovel holster 107 or shovel bag 209 may be made of a durable canvas material, a heavy cloth material or flexible but durable plastic material, to prevent the carrying case from being damaged from the user 206 being buried, while still allowing the carry case to be sufficiently lightweight. It should be understood that each element having an electronic aspect, such as the disclosed lighting apparatus 104, 204 or the GPS, may be provided with a sufficiently high capacity battery or other power source, to allow for the continued usage of the lighting apparatus and/or GPS, as necessary. In an embodiment, a case battery compartment 218 may be nested within the shovel bag 209 (as illustrated by the dotted lines of FIG. 2A), wherein the case battery compartment is configured to house a battery to power the corresponding powered elements (e.g., the case lighting apparatus 204). It should also be understood that the emergency apparatus 100, 200 may include an appropriate carrying case, such as the shovel holster of FIG. 1C or the shovel bag 209 of FIGS. 2A-2C to allow the user to easily carry and access the disclosed foldable shovel 100a enclosed within.

While the emergency apparatus 200 may be helpful to a user 206 who has been trapped under debris such as dirt, rubble, snow, etc., in an emergency situation, the emergency apparatus 200 may also be utilized by individuals who simply need an easy to carry and use shovel that is lightweight. A user who has to occasionally dig through materials may find it useful to wear the disclosed emergency apparatus 200 around, as it provides them with a shovel that they do not need to actively hold in their hands while not in use. In an embodiment, a person who is using a metal detector may find it useful to be wearing or otherwise equipped with the emergency apparatus 200, such that they may only unfold and utilize provided foldable shovel after they have detected something with their metal detector. The wearable nature of the emergency apparatus 200 allows a user to keep both of their hands free until they need to actually start using the foldable shovel, thus making the emergency apparatus 200 useful for various hobbyist and professional applications, in addition to being useful as an emergency tool, as described hereinabove. Furthermore, the aforementioned safety amenities, such as the lighting apparatus 204, leveler apparatus 205 and utility pocket 213 may also find use in non-emergency applications, where applicable.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. An emergency apparatus comprising:
a foldable shovel having:
a shovel handle having a top portion and a bottom portion;
a securing cord attached to the bottom portion the shovel handle;
a shovel pivot attached to the top portion of the shovel handle;
a shovel head attached to the shovel pivot;
a pair of protruding teeth attached to a bottom portion of the shovel head;
a lighting apparatus associated with the shovel handle;
a leveler apparatus associated with the shovel handle; and
a utility slot nested within the shovel handle; and
a carrying case configured to engage with the foldable shovel and secure the foldable shovel to a user;
wherein the securing cord is configured to selectively surround and engage with a wrist of the user and each tooth of the pair of protruding teeth is configured to collide with the shovel handle upon rotation of the shovel head to be about parallel with the shovel handle.

2. The emergency apparatus of claim 1, wherein the carrying case is a shovel bag, the shovel bag comprising a bag body, a main compartment nested within or otherwise engaged with the bag body, wherein the main compartment is configured to selectively hold the foldable shovel, and at least one securing strap associated with the bag body, wherein the at least one securing strap is configured to engage with the user to secure the shovel bag to the user.

3. The shovel bag of claim 2, further comprising a case lighting apparatus associated with the bag body.

4. The shovel bag of claim 2, further comprising a case leveler apparatus associated with the bag body.

5. The emergency apparatus of claim 1, wherein the shovel handle and shovel head are made of acrylonitrile butadiene styrene.

6. The emergency apparatus of claim 1, further comprising a global positioning system device associated with the foldable shovel.

7. The emergency apparatus of claim 1, further comprising an emergency whistle associated with the foldable shovel.

8. The emergency apparatus of claim 1, wherein the lighting apparatus comprises a light emitting diode.

9. An emergency apparatus comprising:
a foldable shovel having:
a shovel handle;
a shovel head pivotally engaged with the shovel handle;
a lighting apparatus associated with the shovel handle;
a leveler apparatus associated with the shovel handle; and
a utility slot nested within the shovel handle; and
a carrying case configured to engage with the foldable shovel and secure the foldable shovel to a user.

10. The emergency apparatus of claim 9, wherein the carrying case is a shovel bag, the shovel bag comprising a bag body, a main compartment nested within or otherwise engaged with the bag body, wherein the main compartment is configured to selectively hold the foldable shovel, and at least one securing strap associated with the bag body, wherein the at least one securing strap is configured to engage with the user to secure the shovel bag to the user.

11. The shovel bag of claim 10, further comprising a case lighting apparatus associated with the bag body.

12. The shovel bag of claim 10, further comprising a case leveler apparatus associated with the bag body.

13. The emergency apparatus of claim 9, wherein the shovel handle and shovel head are made of acrylonitrile butadiene styrene.

14. The emergency apparatus of claim 9, wherein the carrying case is a shovel holster, the shovel holster comprising a securing member configured to engage with the user, wherein the shovel holster is further configured to engage with the foldable shovel.

15. The emergency apparatus of claim 9, further comprising a securing cord attached to the shovel handle, wherein the securing cord is configured to selectively surround and engage with a wrist of the user.

16. The emergency apparatus of claim 9, further comprising a global positioning system device associated with the foldable shovel.

17. The emergency apparatus of claim 9, further comprising an emergency whistle associated with the foldable shovel.

18. The emergency apparatus of claim 9, further comprising a protruding tooth associated with and extending away from the shovel head, wherein the protruding tooth is configured to collide with the shovel handle upon rotation of the shovel head to be about parallel with the shovel handle.

19. The emergency apparatus of claim 9, wherein the lighting apparatus comprises a light emitting diode.

20. An emergency apparatus comprising:
a foldable shovel having:
a shovel handle;
a shovel head pivotally engaged with the shovel handle;
a protruding tooth associated with and extending away from the shovel head;
a lighting apparatus associated with the shovel handle;
a leveler apparatus associated with the shovel handle; and
a utility slot nested within the shovel handle.
